(19) United States
(12) Patent Application Publication
(10) Pub. No.: US 2018/0249863 A1
(43) Pub. Date: Sep. 6, 2018

(54) FOOD HEATING CONTAINER

(71) Applicant: SoMi LLC, Cincinnati, OH (US)

(72) Inventor: Margarita Moksin, Cincinnati, OH (US)

(73) Assignee: SoMi LLC, Cincinnati, OH (US)

(21) Appl. No.: 15/449,258

(22) Filed: Mar. 3, 2017

(51) Int. Cl. A47J 41/00; F24C 7/10; F24C 15/26

(52) U.S. Cl. CPC A47J 41/005; A47J 41/0094; F24C 15/26; F24C 7/10

(57) ABSTRACT

The present invention provides for a portable, wireless and rechargeable heating container (HC) that allows an individual to warm up food. The heating of the food is achieved through an electric heating system powered by the accumulators and controlled by an electronic circuit. HC can heat up the food or drink, up to 40 degrees Celsius (104° Fahrenheit). HC can be used for multiple complete heating cycles on one charging. It contains an on and off switch to activate heating mechanism and an LED indicator for the accumulators, heating and charging status. HC can include a Wi-Fi, BLUETOOTH chip, or any other wireless solution that will enhance its versatility and mobility, allowing it, for example, to access the Internet from a plurality of access points. For purposes of such communication, device preferably includes either or both a wired communications port and a wireless communications port. The system makes it perfect for frequent traveling, outdoors activities and work. The heating container has a convenient design both holding carrying in a bag, an attaching.

### BACKGROUND OF THE INVENTION

### 1. Field of the Invention

The field of art disclosed herein pertains to a wireless portable food and beverage warming device, and more particularly to remotely controlled wireless portable food and beverage warming devices.

### 2. Description of the Related Art

People are becoming more mobile and attentive to what they eat and what they feed themselves and their children. Market offers many alternative ways to simplify preparation of healthy food at home. However, individuals with an active lifestyle, such as regular participation in outdoor activities or frequent travel, can find it challenging to eat and feed their children healthy. Keeping home-made food cool for preservation and finding a way to heat it up on the go may be difficult because of the limiting requirement for an electrical outlet, a microwave, or a stove.

Devices have been disclosed in the prior art that relate to food warming devices. These include devices that have been patented and published in patent application publications. Various devices have been disclosed that generally relate to portable food warming appliances having heating elements for warming food placed therein. However, these prior art devices have several known drawbacks such as merely providing for insulation and not temperature regulation at a set, constant temperature and/or the need to be connected to an electrical outlet.

Beverage containers with provisions for electrically heating the contained beverage are described by, for example, Darn, U.S. Pat. No. 6,121,585. An electrically heated beverage container designed to plug into an automobile cigarette lighter is marketed by The Johnson Smith Company, Bradenton, Fla. as their “Clever Cup.” A container designed for infant milk or formula, in which the fluid can be heated by electrical or exothermic reaction, is taught by Teglbjarg, U.S. Pat. No. 6,123,065. Also known in the art are electrically heated devices for warming infant nursing bottles or food containers, such as the “Baby Bottle and Food Warmer”, Item No. 09234, distributed by One Step Ahead/Leaps And Bounds Co., of Lake Bluff, Ill.; this device is essentially a small electrically heated water bath in which food or drink containers are partially immersed. These devices involve the use of a specialized container for the beverage.

In light of the devices disclosed in the prior art, it is submitted that the present invention substantially diverges in design elements from the prior art and consequently it is clear that there is a need in the art for an improvement to existing food warming devices.

### SUMMARY OF THE INVENTION

In one aspect, the present disclosure provides a new food warming device wherein the same can be utilized for providing convenience for the user when heating food prior to consumption. In another embodiment of the portable food warming device of the present invention, a thermostatic switch is incorporated to maintain the temperature at the optimum point regardless of ambient temperature variations.

In another aspect, the present disclosure provides a portable food warming device that includes a housing having an upper opening. The portable food warming device includes a thermally conductive container contained in the housing an accessible through the upper opening. The portable food warming device includes a lid selectively received in the upper opening to close the housing. The portable food warming device includes one or more rechargeable batteries contained in the housing. The portable food warming device has electrical circuitry contained in the housing comprising: (i) an electrical heater in thermal contact with the thermally conductive container, (ii) a power supply circuit in electrical communication between the electrical heater and the one or more rechargeable batteries to power the electrical heater, (iii) a user control attached to the housing to activate the power supply circuit, (iv) a recharging circuit having a connector that is connectable to an external source of electrical power and that recharges the one or more rechargeable batteries, (v) an output indicator having at least two states to indicate a device status, (vi) a temperature measuring circuit to measure a current temperature of the container, and (vii) a controller in communication with the temperature sensing circuit, the output indicator, and the power supply circuit to activate the electrical heater until a temperature set point sensed by the temperature measuring circuit is reached and to indicate a current device status via the output indicator.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates an isometric view of a Heating Container (HC), according to one or more embodiments;

FIG. 2 illustrates a front side view partially cutaway of HC of FIG. 1 with a detail view of, according to one or more embodiments;

FIG. 3 illustrates an isometric view of an example portable food warmer having an integrally molded body, according to one or more embodiments;

FIG. 4 illustrates a top isometric view of the example portable food warmer of FIG. 3 with a cap removed, according to one or more embodiments;

FIG. 5 illustrates an isometric view of the example portable food warmer of FIG. 3 inserted into a recharging receptacle, according to one or more embodiments;

FIG. 6 illustrates a side cutaway view of the example portable food warmer of FIG. 3, according to one or more embodiments;

FIG. 7 illustrates a functional block diagram of a communication system including the portable food warmer, a smartphone, and a network repository, according to one or more embodiments;

FIG. 8 illustrates a diagram of an example user interface for the portable food warmer, according to one or more embodiments;

FIG. 9 illustrates a flow diagram of a method of remote control of a portable food warming apparatus, according to one or more embodiments; and

FIG. 10 illustrates a flow diagram of a method of scheduled and guided food warming for an intended recipient such as a child having specific feeding requirements, according to one or more embodiments.

### DETAILED DESCRIPTION

The present innovation relates generally to a HC that is a portable and rechargeable heating container that allows an individual to warm food or drink without using traditional heating devices, such as a microwave or a stove. In one embodiment, the warming device comprises a housing that resembles a thermos or a pot. The housing includes an interior volume defining a heating chamber in which food can be placed for heating. The housing includes a charging dock and a battery powered heating element operated via a control switch for electrically heating the food within the heating chamber. Once charged, the device is operable without being plugged into an electrical outlet.

The design of the invention can take on any number of configurations, depending on the intended use of the device. All configurations have at least the following components, at least one internal compartment holds the contents to be warmed, such as food, liquids, lotions, or towelettes. This compartment can be of a different size and shape dependent on the intended use.

In one or more embodiments, the heating of the food is achieved through an electric heating system powered by the accumulators and controlled by an electronic circuit. The HC can heat up the food or drink, up to 40 degrees Celsius (104° Fahrenheit). The HC can be used for multiple, complete heating cycles on one charging. The housing includes a charging dock and a battery powered heating element operated via a control switch for electrically heating the food within the heating chamber so the EEC could be used away from any external power source. Once charged, the device is operable without being plugged into an electrical outlet. The device comprises an on and off switch to activate heating mechanism and has an indicator, such as an LED or OLED light or screen, for the accumulators, heating and charging status. The system makes it perfect for traveling and parent on the go. The HC has a convenient design perfect for both holding and carrying in a bag. The device of the present invention can readily be used at any time to provide heat for a food or liquid, it being only necessary to periodically recharge the power unit by plugging it into a wall socket or other alternate power source such as charging dock, solar panels, and other developed power source.

Although the present invention has been described as employing a rechargeable battery, itis within the scope of the present invention to utilize non-rechargeable, disposable batteries. It is also within the scope of the present invention to utilize a known, conventional battery supply within the heater assembly. If desired, the battery-equipped container wanner could contain a switch to select between “Heat” and “Recharge” modes, to allow use of external electrical power when available to maintain the hot beverage at the desired temperature. Alternately, the battery-equipped container warmer could contain an On-Off switch for the heater, in embodiments where the container warmer would be continually recharging when connected to the external power source. In further alternative embodiments of embodiments of the HC of the present invention comprising batteries in a separable unit, the battery unit would preferably be detachably attached and electrically disconnectably connected to the HC, so that it could be removed and connected to a suitable battery recharging unit. The design and fabrication of a suitable recharging unit would be within the purview of one skilled in the art. Extra battery units could be provided, so that a user of the HC of the present invention could always have a fully charged battery available whenever the user wished to heat a food product.

The device of the present invention is a portable HC powered by rechargeable accumulators, with high efficiency. The challenge is to bring to consumer market a product, which is able to use in a smart way the high heating capacity of the wires (such as thin and thick film resistors and Khanthal® wires), while consuming a small quantity of electrical energy as possible from the accumulators. In an exemplary embodiment, the HC is designed for the following specification requirements: (i) Container volume: 330 ml; (ii) Heating interval: 5° C.-40° C.; (iii) Power capacity: up to 3 heating cycles; and (iv) Electronic control and live monitoring of the heating process.

The device of the present invention may be used for containing a temperature degradable liquid such as milk. For example, the container's cavity may be filled with milk at about 4° C. To avoid food poisoning or dispensing of degraded milk, such milk should not be used once its temperature has exceeded 10 to 15° C. To avoid dispensing of degraded milk, the container includes a device to monitor the temperature of the liquid in the container's closed cavity.

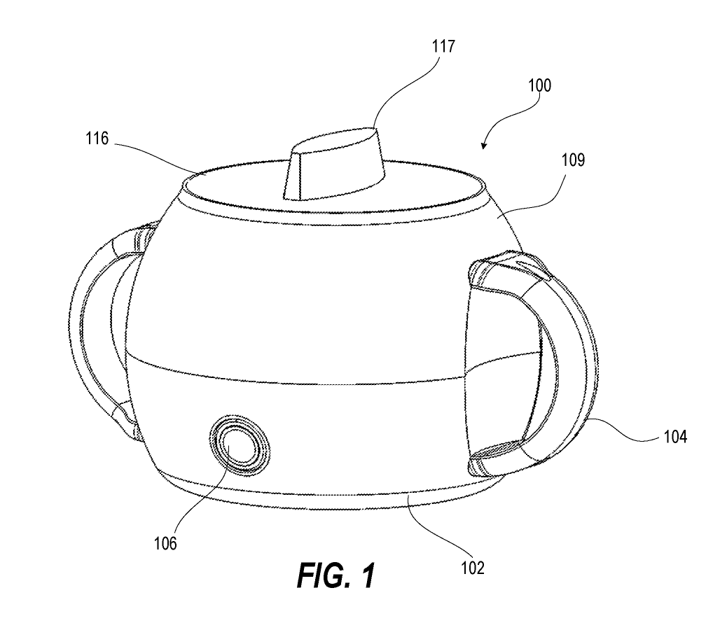

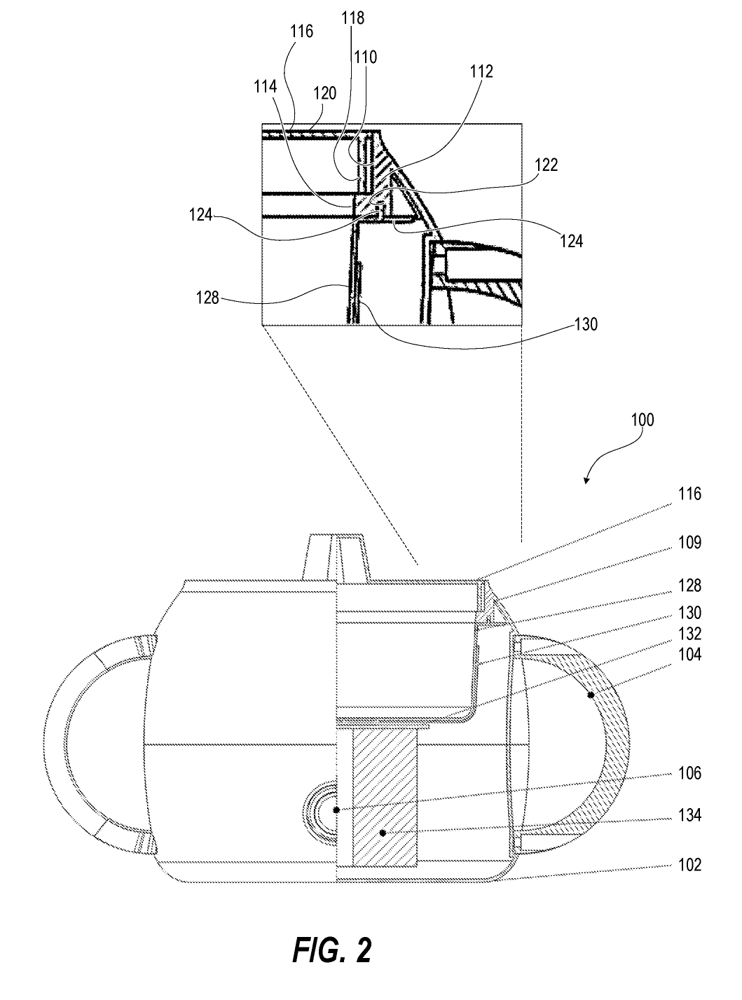

FIGS. 1-2 illustrate an example portable heating container 100 that operates off of a portable electrically rechargeable power source. With particular reference to FIG. 2, the portable heating container 100 includes a lower housing 102, which can be formed from molded plastic. In one or more embodiments, one or more handles 104 are attached to an exterior surface of lower housing 102. The exterior of the lower housing 102 includes a user control and indicator, such as a button 106 that turns on and off active components of the portable heating container 100. In an exemplary embodiment, the button 106 contains a bicolor Light Emitting Diode (LED) that indicates a device status such as: (i) on and warming; (ii) on and warmed to a set temperature; and (iii) off.

The lower housing 102 generally has a vessel shape that transitions to an upper housing 109 with an upper opening 110 with a inwardly (downwardly) projecting cylindrical ring 112 having a bottom annular flange 114 extending horizontally and inwardly to narrow a circumference of the cylindrical ring 112. A generally circular lid 116 with an upward handle 117 has a downward cylindrical ring 118 extending from a circumference of a top disk 120. The downward cylindrical ring 118 of the lid 116 is received within the cylindrical ring 112 of the upper housing 109 and to rest upon the bottom annular flange 114. A bottom surface of the bottom annular flange 114 of the upper housing 109 includes an annular groove 122 that receives a corresponding snap fit ring 124 extending upwardly from an outer annular flange 126 surrounding a container 128. In one embodiment, the container 128 can be anodized aluminum and have an internal volume of 330 ml. An undersurface of the top disk 120 of the lid 116 can include an attachment feature to hold an eating utensil such as a spoon (not shown).

A heating element 130 warms the container 128. In an exemplary embodiment, the heating element 130 is thick film resistors that are in contact with an exterior of the container 128. A printed circuit board (PCB) 132 includes active functional components powered by batteries 134 that selectively power the heating element 130. In one embodiment, one or more batteries 134 are six (6) rechargeable lithium 18650 batteries that each can provide 3000 mAh of power.

A stirring element may be configured and disposed to mix a product or move around a product within the retainer. Examples of a stirring element include a stirring rod, a straw, a magnetic stirrer, a vibration unit, or other. In an exemplary embodiment, the Heating Container 100 may be provided with a stirrer (not shown) that may be coupled within the cavity of the heating container 100. The stirrer may be a mechanical/magnetic stirrer that may be activated by a switch (not shown). More specifically, the stirrer may be activated by the switch to facilitate stirring the fluid content in the heating container 100. In an alternate exemplary embodiment, the stirrer may be substituted with any type of agitator device known in the art that facilitates the fluid in the heating container 100 from attaining a homogenous constitution while maintaining uniform temperature. In an exemplary embodiment, the stirrer may be coupled to a controller, wherein the controller automatically stirs contents with the stirrer according to present parameters.

In an exemplary embodiment, the heating container 100 may be provided with a cooling element. A cooling element may be a refrigerant, ice unit, fan, or other cooling mechanism configured to decrease the temperature of the retainer, lid, product, or other contents of the retainer.

In an exemplary embodiment, the heating container 100 may be provided with a treatment element. A treatment element may include a filtering or other purifying element, flavor emitting element, fragrance emitting element, liquid conditioning element, cleaning element, or other treatment of the lid, retainer, product, or other contents of the retainer.

Certain embodiments of the system and methods of the present invention include one or more computer elements. Examples of computer elements include a processor, system memory, cache, system bus, chassis, fan, power source, basic input/output system (BIOS), hard disk drive, optical disk drive, non-transitory computer-readable medium, and USB or serial port. Certain embodiments of the present invention may include additional components. For example, embodiments of the present invention may include a power source, such as a battery, capacitor, flywheel, near-field inductance circuit, solar cell, generator (e.g., micro generator, thermoelectric generator, inductive generator, piezoelectric generator, etc.), or power plug (e.g., two prong, three prong, European standard). Embodiments of the present invention also may include a power distributor such as a lithium ion power distributor.

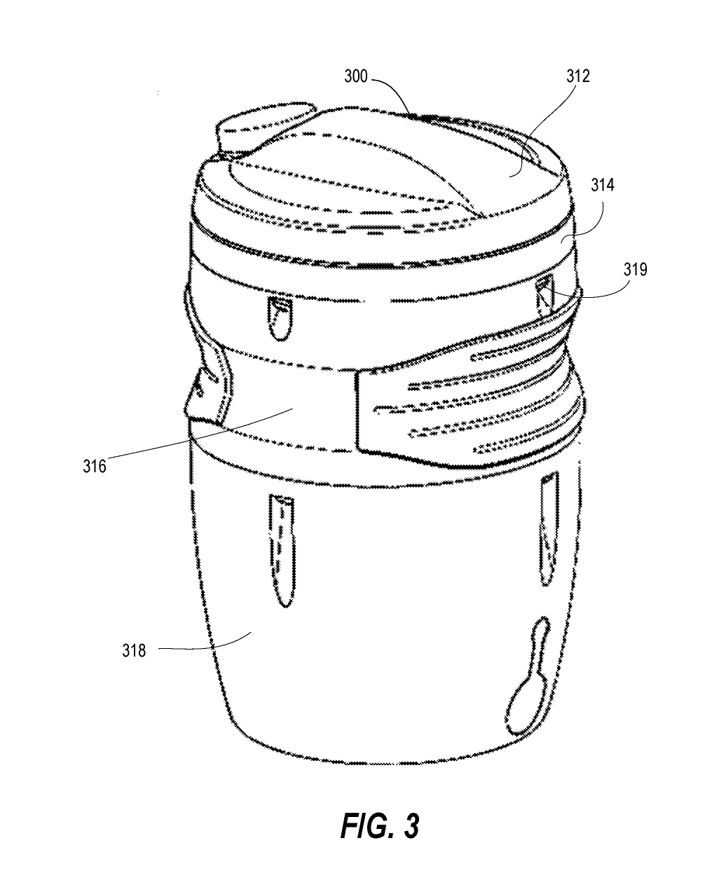

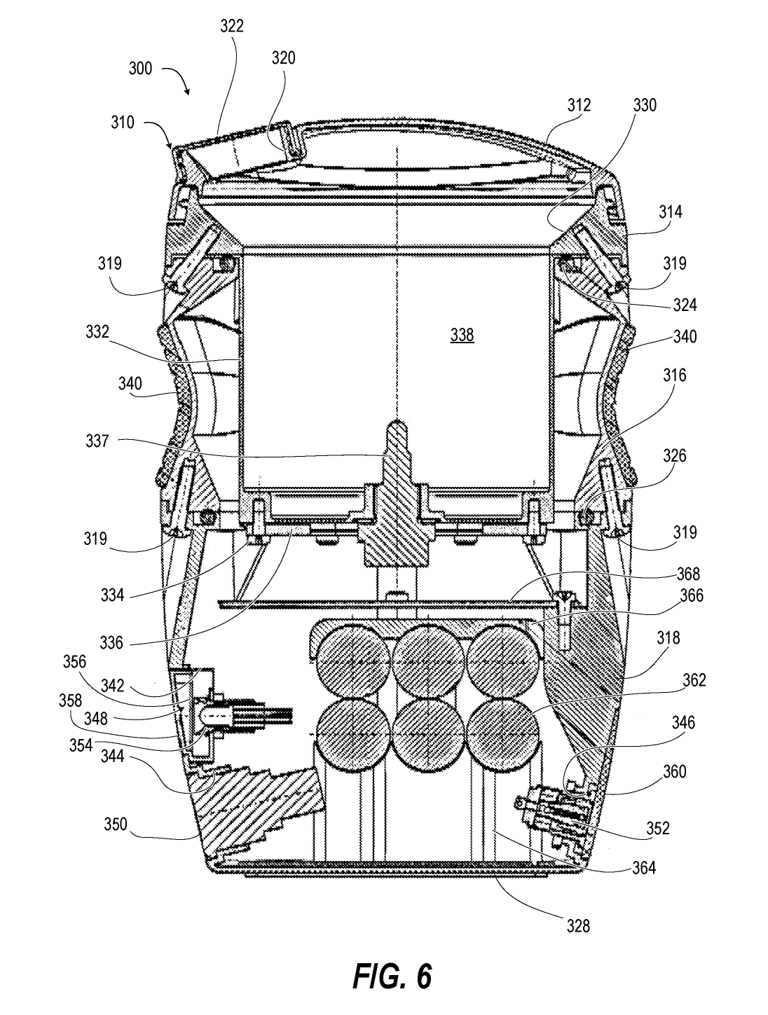

FIGS. 3-6 illustrate an exemplary portable food warmer 300 having an integrally molded body 302 that that is assembled with screws 304. FIG. 3 illustrates that the portable food warmer 300 includes molded parts that form an enclosure 310 including a cap 312, a top cover 314, a top housing 316, and a bottom housing 318, with all but the cap 312 secured together by M3.5×16 Taptite screws 319. FIG. 6 illustrates that the cap 312 has internal threads that engage external threads of the top cover 314. The cap includes a pour nozzle 320 that is closed by a pouring nose threaded cap 322. A top O-ring 82.00×4 324 seals the top cover 314 to the top housing 316. A bottom O-ring 92.00×4 326 seals the top housing 316 to the bottom housing 318. One or more rubber pads 328 cover a bottom surface of the bottom housing 318.

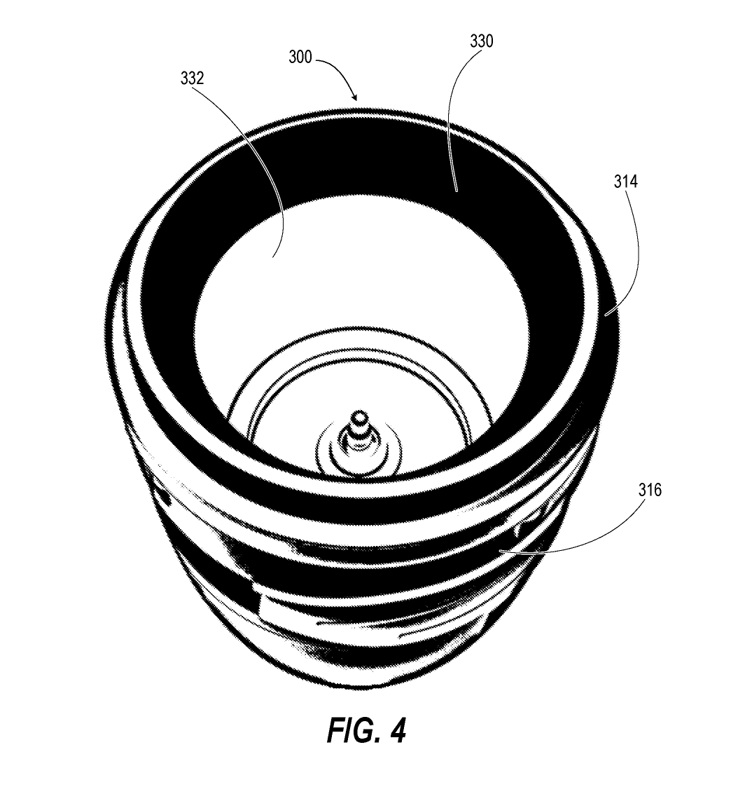

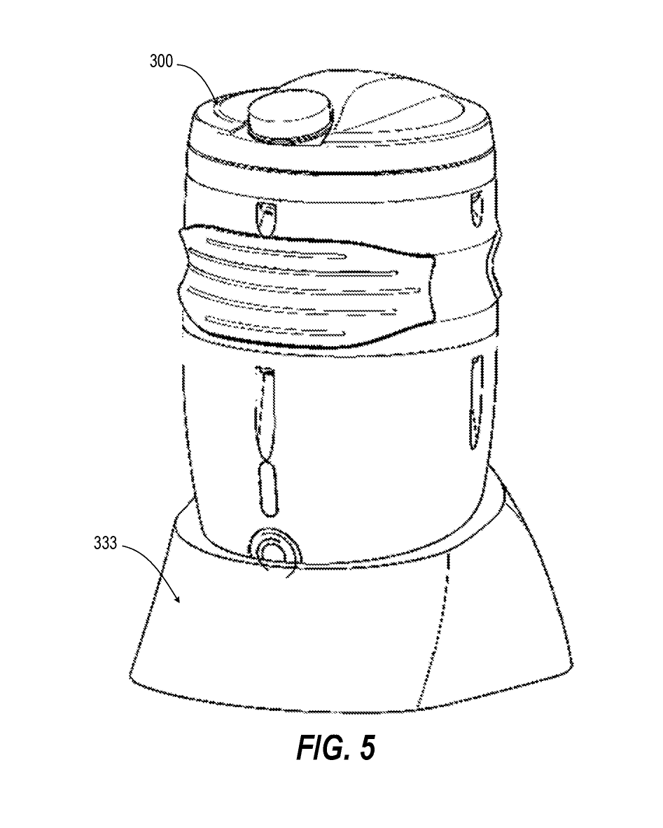

FIGS. 4 and 6 illustrate that the top cover 314 defines a funnel mouth 330 that transitions to a cylindrical inner container 332 attached inside the top housing 316 by six M3/×6 fasteners 334. FIG. 5 illustrates a recharge receptacle 333 that receives the portable food warmer 300. FIG. 6 illustrates that four heating resistors 336 are also secured to a bottom peripheral surface of the inner container 332. In a center of the bottom surface of the cylindrical container 332, a temperature sensor 337 extends into a vessel cavity 338 defined by the inner container 332, top cover 314 and cap 312. Two rubber side grips 340 are attached to opposing exterior sides of the top housing 316. Apertures 342, 344, 346 respectively in the bottom housing 318 receive a light emitting display (LED) display assembly 348, an LED control button 350, and a charging connector 352. The LED display assembly 348 includes an LED support 354 onto which is mounted an LED display 356. The aperture 342 is closed with an LED cover 358. In one or more embodiments, LED control button 350 is disposed upon the bottom housing 318 in a location and orientation providing easy access and clear visibility. In one or more embodiments, LED control button 350 serves as an on/off button permitting a user to provide power and to cut off power o portable food warmer 300

Aperture 346 is closed by a charging connector rubber lid 360. Inside of the bottom housing 318, six 18650 rechargeable batteries 362 are supported between battery supports 364 and a battery cover 366. Above the battery cover 366, a printed circuit board (PCB) 368 is attached inside of the bottom housing 318 and contains functional controls of the portable food warmer 300.

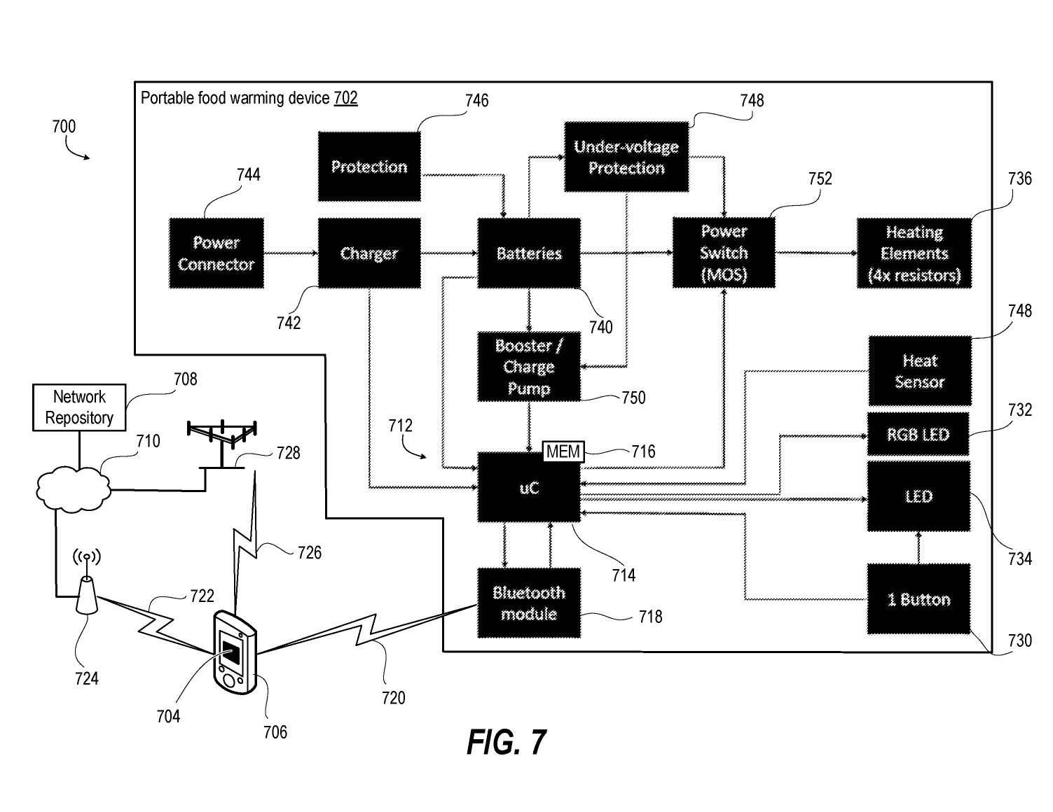

FIG. 7 illustrates a communication system 700 including a portable food warming device 702 that communicates with a remote control application 704 on a remote control device such as a smartphone 706. The portable food warming device 702 either directly or through assistance from the smartphone 706 can access additional information from a network repository 708 over a network 710. Certain control functions can be exclusively provided on one of the portable food warming device 702 and the smartphone 706. Alternatively, certain control functions can be provided by both of the portable food warming device 702 and the smartphone 706. Centralized or distributed computing capabilities of the portable food warming device 702, the smartphone 706 and the network repository 708 can function together to operate as an information handling system (IHS) 712. For purposes of this disclosure, IHS 712, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a handheld device, personal computer, a server, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For clarity, IHS 712 includes a processor (“μC”) 714 having a memory 112. Processor subsystem 110 may include any system, device, or apparatus configured to interpret and/or execute program instructions and/or process data, and may include, without limitation a microprocessor, microcontroller, digital signal processor (DSP), Application Specific Integrated Circuit (ASIC), or any other digital or analog circuitry configured to interpret and/or execute program instructions and/or process data such as an operating system. In some embodiments, processor 714 may interpret and/or execute program instructions and/or process data stored in memory 716 and/or another component of IHS 712. Memory 716 may be communicatively coupled to processor 712 and may include any system, device, or apparatus configured to retain program instructions and/or data for a period of time (e.g., computer-readable media). By way of example without limitation, memory 716 may include RAM, EEPROM, a PCMCIA card, flash memory, magnetic storage, opto-magnetic storage, or any suitable selection and/or array of volatile or non-volatile memory that retains data after power to IHS 712 is turned off or power to IHS 712 is removed. Network interface, such as a bluetooth module 718 may include any suitable system, apparatus, or device operable to serve as an interface between IHS 712 and smartphone 706 or network 710. For example, IHS 712 can include a personal access network (PAN) 720 between the portable food warming device 702 and the smartphone 706. The smartphone 706 can include a wireless local access network (WLAN) link 722 to a node 724 that in turn is communicatively coupled to the network 710. Alternatively or in addition, the smartphone 706 can communicatively couple over a wireless wide area network (WWAN) link 726 such as via cellular communication to a radio access network (RAN) 728. IHS 712 can communicate using any suitable transmission protocol and/or standard, including without limitation all transmission protocols and/or standards enumerated herein with respect to the discussion of network 710. The term “communications network” can include the Internet as manifested by the World Wide Web (WWW) of computers, and to Intranets or Extranets or any other open or closed communications networks, including GSM and. GPRS cellular networks, satellite networks, cable networks and local area networks, either wired or wireless.

Processor 712 can receive control inputs from a single control button 730 and provide status indications on a red green blue (RGB) light emitting diode (LED) 732. Processor 712 can also interact with inputs or outputs provided via an LED display 734. Processor 712 can provide closed loop control of heating elements 736 by monitoring a heat sensor 738 that includes measurement circuit that measures the container temperature using a thermistor or a temperature sensor. The heat sensor 738 can be for example a thermocouple-based or thermoresistive-based or thermistor-based sensor or any other system allowing the measuring of a temperature connected to the circuit. Batteries 740 that power the heating elements 736, RGB LED 732 and LED display 734 are charged by a charger 742 that receives power from a power connector 744. A protection circuit 746 prevents overcharging of the batteries 740. An under-voltage protection circuit 748 controls a booster/charge pump 750 to maintain a voltage level that is satisfactory for powering the processor 714. The processor 714 triggers a metal oxide silicon (MOS) power switch 752 that receives power from the batteries and under-voltage protection circuit 748 to cause power to flow to the heating elements 736.

Processor 714 executes software that performs functions such as: (i) verifies that all the conditions are fulfilled in order to start the device when the button is pressed; (ii) opens the power supply circuit through transistor; (iii) indicates the device status using a LED; and (iv) stops the device when the desired temperature is reached.

Processor 714 can participate in communication of data relating to liquids and/or foods via the communications network 700. HIS 712 is preferably equipped for both sending and receiving data related to formulae and/or fluid foods and is capable of receiving input related to the preparation of a liquid or food using an available formula from a remote source and will similarly be capable of providing user output to a remote source.

Accordingly, device 100 is preferably provided with one or more of a range of communication apparatus that allows device 100 to communicate directly through either a hardwire communication mode (e.g., dial-up, LAN, or WAN) or a wireless communication mode (e.g., infrared or radio frequency) or a combination thereof. Device 100 can include a Wi-Fi, BLUETOOTH chip, or any other wireless solution that will enhance its versatility and mobility, allowing it, for example, to access the Internet from a plurality of access points. For purposes of such communication, device 100 preferably includes either or both a wired communications port and a wireless communications port.

It will be appreciated that the list of user client types, the list of devices that constitute a computer and the list of communications networks are not to be regarded as limiting. Further embodiments of device 100 may adopt all emerging technology to communicate in every way and with every device that advances its function.

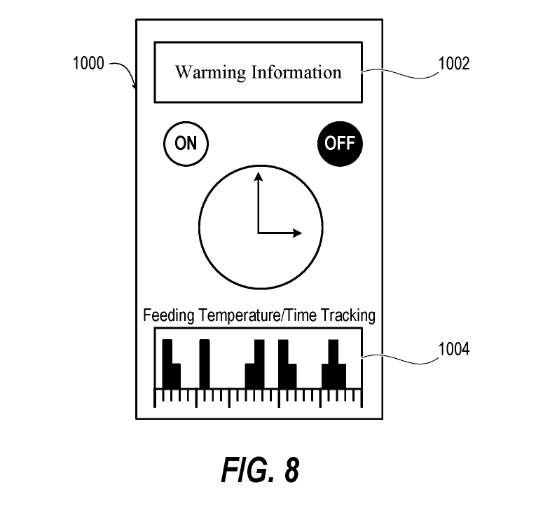

FIG. 8 illustrates an example user interface 1000 that is displayed on at least one of the LED display 734 (FIG. 7) or the smartphone 706 (FIG. 7). Information 1002 related to the food or recipient that is retrieved from a remote source can be displayed. Historical feeding data 1004 that is tracked can be displayed to assist a user. The user interface 1000 can enable a user to do functions such as: (a) Set temperature and adjust; on/off; log parameters; (b) Alarms and/or logging of feeding times and amounts; (c) Pull articles from web sites to share information; (d) Input articles (upload) for others; and (e) Get advice/tips.

It is understood that the user interface 1000 depicted is solely exemplary and is so depicted to show representative features that may be included in any interface 1000 provided in the various embodiments of which portable food warming device 300 (FIG. 3) is capable. Therefore, it is understood that embodiments of portable food warming device 300 (FIG. 3). need not have every one of the features and elements shown and may have additional features and elements not shown. Moreover, the features and elements shown may be arranged in any convenient or esthetically pleasing design including being located separately in different locations.

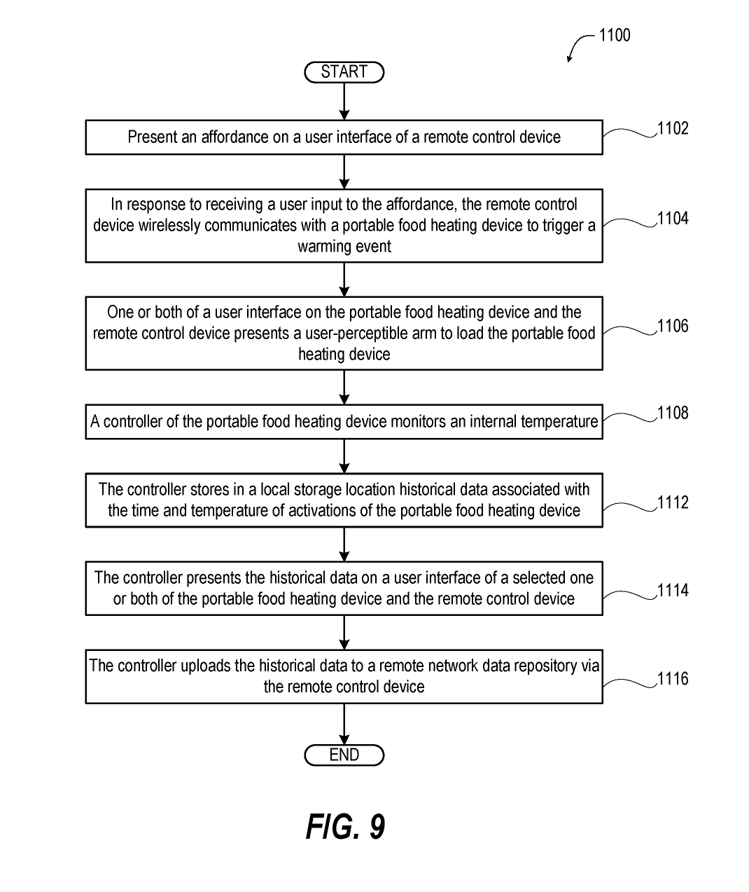

FIG. 9 illustrates a method 1100 of remote control of a portable food warming apparatus. In one or more embodiments, the method 1100 includes presenting an affordance on a user interface of a remote control device (block 1102). In response to receiving a user input to the affordance, the remote control device wirelessly communicates with a portable food heating device to trigger a warming event (block 1104). One or both of a user interface on the portable food heating device and the remote control device presents a user-perceptible arm to load the portable food heating device (block 1106). A controller of the portable food heating device monitors an internal temperature (block 1108). The controller stores in a local storage location historical data associated with the time and temperature of activations of the portable food heating device (block 1110). The controller presents the historical data on a user interface of a selected one or both of the portable food heating device and the remote control device (block 1112). The controller uploads the historical data to a remote network data repository via the remote control device (block 1114).

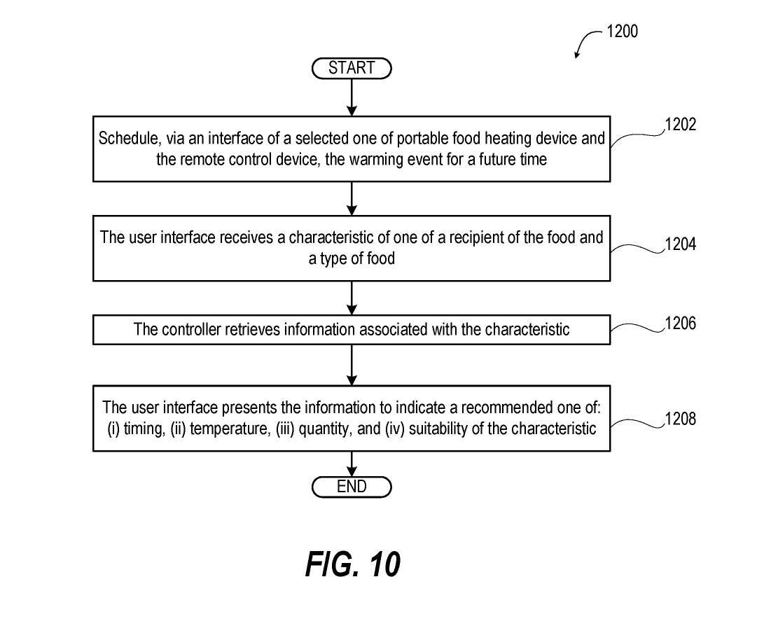

FIG. 10 illustrates a method 1200 of scheduled and guided food warming for an intended recipient such as a child having specific feeding requirements. In one or more embodiments, the method 1200 includes scheduling, via an interface of a selected one of portable food heating device and the remote control device, the warming event for a future time (block 1202). The user interface receives a characteristic of one of a recipient of the food and a type of food (block 1204). The controller retrieves information associated with the characteristic (block 1206). The user interface presents the information to indicate a recommended one of: (i) timing, (ii) temperature, (iii) quantity, and (iv) suitability of the characteristic (block 1208).

In a still further alternative embodiment of the container warmer of the present invention, the device can be sized and shaped to accommodate a motor vehicle cup-holder for incorporation in motor vehicles either as original equipment or, alternately, for later installation, which could accommodate the HC of the present invention, and comprise means to supply electric power to the container warmer, and also to recharge the battery if the container warmer comprises a rechargeable battery. This latter embodiment would have the advantage of using the motor vehicle's electrical system to keep the food or liquid at optimum temperature for consumption, and keeping the battery unit fully charged, while the user is in the motor vehicle, while at the same time affording portability, allowing the user to take the HC out of the motor vehicle and still maintain proper temperature,

In another alternative embodiment, the HC of the present invention could be fabricated in the form of a container holder detachably attached to a portable computer, and comprising electrical heating means powered by the portable computer's battery or line-voltage power. Such embodiment would provide the advantage of keeping the computer user's food or beverage at optimum temperature while using the computer in airports, airplanes, busses or trains, etc.

Many of the embodiments described above incorporate batteries as sources of electric power. The inventors of the present invention are aware that miniature fuel cells are currently under development which could conceivably replace batteries at some time in the future in many applications requiring stored electric power. The present invention contemplates the use of such miniature fuel cells as an alternate for batteries to supply the necessary electric power to operate the /IC of the present invention.

Device 100 is designed to be programmable and to both provide a user with data and information and also to accept input from a user to decide the composition, quantity and temperature of the fluid or food to be prepared.

In one or more embodiments, interface 620 includes a visual display 630 that serves as an output interface. Device 100 communicates with a user via display 630 that is preferably an LCD monochrome or color display screen capable of showing text. It is appreciated that alternate embodiments may be capable of showing graphics and still or moving graphic and photographic images. It is further appreciated that future embodiments may have screens of larger or smaller dimensions, capable of displaying more or less or different types of data. Interface 620 may also include an auditory output interface (not shown), such as an integral speaker, for providing audible signals such as alerts, warnings or information regarding certain conditions that prevail, such as low water levels and the like.

Device 100 may also, in alternate embodiments, use a remote computing device as an input interface and be used for the input of data. For example, the device can communicate with a mobile device application via Bluetooth® connectivity. According to an alternate embodiment, remote computing device display 630 could include a touch sensitive digitizer pad that can detect contact by any type of pointer, from a stylus to a simple finger ouch. Through such a touch sensitive display 630, interface 620 could input data in a number of different modes. First, it could display a virtual and touch functional keyboard. In order to key in data, the user touches display 630 on the desired key of the keyboard and the character of that key appears in the open field. Display 630 could display scrolling or windows-like data menus from which alternatives are selectable by touch. Thus, display 630 could allow entry of data by touch selecting the desired data from displayed lists or menus. Display 630 could serve as a sensor for character recognition that recognizes a tracing and replaces the recognized character with a legible and easily identifiable version in the desired location.

According to the preferred embodiment, the primary input capabilities of interface 620 will be via one or more finger-pressable buttons. It is understood that the following description of the use, function and designation of the buttons is solely exemplary and any configuration, combination or marking of buttons that effect the functioning of device 100 may be used.

Interface 630 includes a plurality of function selection buttons, referred to hereinafter in the aggregate as buttons 634. Pressing each button with a fingertip or other object will cause the relevant function to be activated. Accordingly, interface 630 will display information or data related to the function selected and will accept input related thereto.

It will be appreciated that the number, configuration,location and function of all of the input and output components of interface 630 are not critical elements of the design of user interface 630 nor of device 100 and further embodiments may deploy these components in various ways, including the inclusion of jacks and ports comprising open architecture whereby remote input and output devices may be employed.

All publications, patents and patent applications cited herein, whether supra or infra, are hereby incorporated by reference in their entirety to the same extent as if each individual publication, patent or patent application was specifically and individually indicated as incorporated by reference. It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A portable food warming device comprising:
A housing having two upper opening (one small pouring nose and one large);
a thermally conductive container contained in the housing an accessible through the upper opening;
a lid selectively received in the upper opening to close the housing;
one or more rechargeable batteries contained in the housing;
electrical circuitry contained in the housing comprising:
an electrical heater in thermal contact with the thermally conductive container,
a power supply circuit in electrical communication between the electrical heater and the one or more rechargeable batteries to power the electrical heater,
a user control attached to the housing to activate the power supply circuit,
a recharging circuit having a connector that is connectable to an external source of electrical power and that recharges the one or more rechargeable batteries,
an output indicator having at least two states to indicate a device status,
a temperature measuring circuit to measure a current temperature of the container, and
a controller in communication with the temperature sensing circuit, the output indicator, and the power supply circuit to activate the electrical heater until a temperature set point sensed by the temperature measuring circuit is reached and to indicate a current device status via the output indicator.

2. The portable food warming device of claim 1, further comprising a recharging base comprising:
base that receives the housing;
a power supply connected to the external source of electrical power; and
an electrical interface attached to the base to couple an electrical power to the recharging circuit.

3. The portable food warming device of claim 1, further comprising a wireless communication component, wherein the user interface comprises a remote user device that communicates with the wireless communication component.

4. The portable food warming device of claim 3, wherein:
the remote user device is communicates with a network data repository of container related information; and
the user interface accesses: (i) a characteristic of a food or liquid placed in the housing (for example, temperature, volume), (ii) retrieves information from the network data repository associated with the characteristic, and (iii) presents the information.

5. The portable food warming device of claim 4, wherein:
the remote user device comprises a camera and a scanning utility that reads identifying indicia on packaging of a food product;
the user interface communicates with the network data repository to associate the identifying indicia with the food; and
the information retrieved is associated with the food.

6. The portable food warming device of claim 5, wherein the user control and output indicator comprise a push button having a multicolor status indication component.

7. The portable food warming device of claim 5, wherein:
the controller comprises a chronometer; and
the user interface presents an affordance to schedule the chronometer for activating the power supply circuit.

8. The portable food warming device of claim 7, wherein the controller is responsive to the schedule of the chronometer to present at least one of an audible and visible alarm via the user interface.

9. The portable food warming device of claim 1, wherein:
the controller comprises a memory, the controller storing in memory historical data of at least one of: (i) an operating time and (ii) a temperature profile; and
the user interface presents the historical data.

10. The portable food warming device of claim 1, wherein the external power source comprises a photovoltaic cell.

11. The portable food warming device of claim 1, wherein the external power source comprises a replaceable fuel cell.

12. The portable food warming device of claim 1, further comprising a replaceable insert that receives food and that sized to be closely received within the housing.

13. The portable food warming device of claim 1, wherein the housing comprises an impact resistant and insulating material for use in one of emergency, military, camping and outdoor environments.

14. The portable food warming device of claim 1, wherein the housing comprises solar cells for charging.

15. The portable food warming device of claim 1, wherein:
the user interface presents an affordance for selecting a temperature setting; and
the controller is responsive to the temperature setting in controlling the electrical heater to maintain the temperature setting.

16. A method comprising:
presenting an affordance on a user interface of a user device;
in response to receiving a user input to the affordance, wirelessly communicating with a portable food heating device to trigger a warming event;
presenting a user-perceptible arm to load the portable food heating device;
monitoring temperature of the portable food heating device;
storing historical data associated with the time and temperature of activations of the portable food heating device; and
presenting the historical data on a user interface.

17. The method of claim 16, further comprising:
uploading the historical data to a remote network data repository.

18. The method of claim 16, further comprising:
receiving a characteristic of one of a recipient of the food and a type of food;
retrieving information associated with the characteristic; and
presenting the information to indicate a recommended one of: (i) timing, (ii) temperature, (iii) quantity, and (iv) suitability of the characteristic.

19. The method of claim 16, further comprising scheduling the warming event for a future time.
